(19) United States
(12) Patent Application Publication
(10) Pub. No.: US 2023/0022279 A1
(43) Pub. Date: Jan. 26, 2023

(54) AUTOMATIC INTRUSION DETECTION BASED ON MALICIOUS CODE REUSE ANALYSIS

(71) Applicant: VMware Inc., Palo Alto, CA (US)

(72) Inventors: Roman Vasilenko, Boston, MA (US); Corrado Leita, Goleta, CA (US); Corrado Raimondo, London (GB)

(21) Appl. No.: 17/383,285

(22) Filed: Jul. 22, 2021

(51) Int. Cl. G06F 21/56; G06F 21/55

(52) U.S. Cl. CPC G06F 21/564; G06F 21/554

(57) ABSTRACT

Methods, systems, and apparatus, including computer programs encoded on computer storage media, for automatically generating intrusion detection system (IDS) signatures. One of the systems includes obtaining a new data object and determining whether the new data object is malicious or not malicious; identifying a plurality of components of the new data object; updating tracking data that identifies, for each of a plurality of tracked components of previous data objects, a frequency with which the tracked component has been identified in previous data objects determined to be malicious and a frequency with which the tracked component has been identified in previous data objects determined not to be malicious; and determining, from the tracking data, that one or more particular tracked components satisfy one or more conditions and, in response: automatically generating a new IDS signature for identifying malicious data objects that include the one or more particular tracked components.

### BACKGROUND

This specification generally relates to intrusion detection systems (IDS) that analyze data objects downloaded by one or more devices in a network of devices to determine whether the data objects are malicious.

Some intrusion detection systems are network intrusion detection systems (NIDS) that are placed at different points across a network and that monitor the traffic to and from each device in the network. Some other intrusion detection systems are host intrusion detection systems (HIDS) that monitor the inbound and outbound traffic of a single device only.

Some intrusion detection systems, including some NIDSs and some HIDSs, monitor data objects “on the wire,” i.e., as the data object is downloaded by devices in the network, and do not require access to the entire data object at once to determine whether the data object is malicious. Rather, as the system downloads a data stream representing the data object, the intrusion detection system can apply one or more IDS signatures to a sliding window of the data stream to determine whether the data object is malicious. Such intrusion detection systems are often called “signature-based” intrusion detection systems.

Some intrusion detection systems are also intrusion prevention systems (IPS), sometimes called intrusion detection and prevention systems (IDPS). An intrusion prevention system is configured to take an action if a data object is determined to be malicious. For example, an intrusion prevention system can be configured to reject the data object, i.e., not allow the data object to be downloaded by devices in the network, if the data object is determined to be malicious.

### SUMMARY

This specification generally describes a system that can automatically generate new IDS signatures for identifying malicious data objects.

The system can be configured to maintain data that identifies, for each of multiple components that have been observed in data objects analyzed by the system, a frequency with which the component has been observed in data objects identified as malicious and in data objects identified as benign. The system can use the maintained data to identify one or more components that are frequently observed in malicious data objects, and automatically generate an IDS signature that will be triggered by the one or more components. That is, when the new IDS signature is applied to a new data object, the new IDS signature will match the data object if the data object includes the one or more components.

It is rare for a new malicious data object to be generated entirely from scratch. Rather, those who generate new malicious data objects often re-use components from older malicious data objects. For example, when designing computer programs for new computer viruses, malicious developers often re-use functions from existing computer viruses. Thus, malicious data objects generally evolve slowly over time, with new functionalities and bug fixes added to the data objects but many old components remaining the same. Therefore, when a system analyzes a malicious data object, even if the system has never observed the malicious data object previously, by disassembling the malicious data object into its constituent components, the system can often identify one or more components that have previously been observed in other malicious data objects.

Even when a component is updated before being included in a new malicious data object, often the changes are superficial. For example, a malicious developer may change the names of variables and subroutines within the component while keeping the functionality of the component the same. When tracking historical observations of components of data objects, systems described in this specification can disregard the features of the components that are often modified (e.g., by maintaining a bitmask that masks out these features), so that the component can be identified in future data objects even if the component is superficially changed.

Thus, when a component is frequently observed in malicious data objects, but rarely observed in benign data objects, the system can determine that the component can be used as an indicator that a data object is malicious, and automatically generate a new IDS rule that is triggered by the component.

Particular embodiments of the subject matter described in this specification can be implemented so as to realize one or more of the following advantages.

In some existing systems, expert engineers must manually generate new IDS signatures, e.g., by inspecting a malicious data object, identifying a pattern in the malicious data object, and designing an IDS signature to match the pattern. This process can be time-consuming and expensive. Using techniques described in this specification, a system can automatically generate new IDS signatures using data characterizing previous data objects analyzed by the system, without requiring any human input. In this way, the system can significantly reduce the time and cost required to generate new IDS signatures.

In particular, using techniques described in this specification, a system can be configured to automatically determine components of data objects that indicate that the data object may be malicious. Using the tracked data, the system can identify patterns in malicious data objects that may have eluded expert engineers, thus allowing the system to generate IDS signature that are more effective than hand-designed IDS signatures.

In some existing systems, IDS signatures only match data objects that have previously been observed. Thus, if a new malicious data object is encountered by the system, the system is unable to identify the data object as malicious. Using techniques described in this specification, a system can generate IDS signatures that are resistant to changes in unstable portions of malicious data objects. Thus, the system can identify a data object as malicious even if the data object has never before been observed by the system.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example system.

FIG. 2 is an illustration of an example component tracking table.

FIG. 3 is a flow diagram of an example process for automatically generating an IDS signature.

Like reference numbers and designations in the various drawings indicate like elements.

### DETAILED DESCRIPTION

This specification describes techniques for automatically generating intrusion detection signatures.

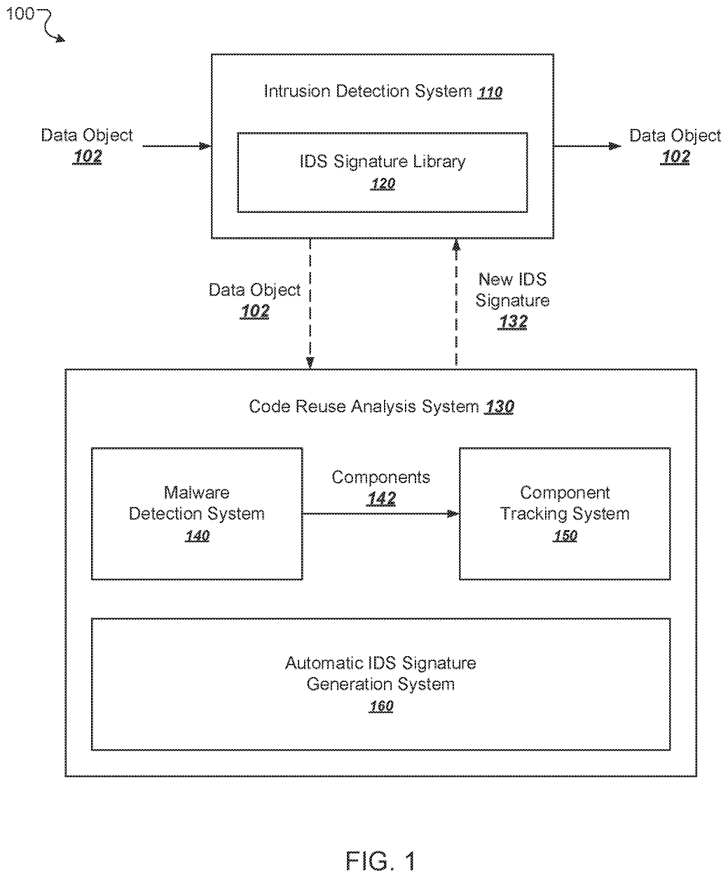

FIG. 1 is a diagram of an example system 100. The system 100 includes an intrusion detection system 110 and a code reuse analysis system 130.

The intrusion detection system 110 is configured to monitor network traffic that is entering a network of one or more devices for malicious activity. In particular, for each data object that is received by the network, the intrusion detection system 110 is configured to determine whether the data object is malicious. In this specification, a data object is “malicious” if the data object is to harm the network, e.g., by disrupting operations of the network or of an entity of the network, damaging the network or an entity of the network, or gaining unauthorized access to the network or an entity of the network. A malicious data object can be any type of malware, e.g., a computer virus, a computer worm, a Trojan horse, adware, ransomware, spyware, or a keylogger. The entity of the network can be any appropriate entity, e.g., a device in the network, a system of multiple devices in the network, a computer program executing on one or more devices in the network, and so on.

In some implementations, the intrusion detection system 110 is maintained by the same entity as the network. For example, if the network is a network of devices associated with an organization, then the intrusion detection system 110 can be maintained by an information technology (IT) department of the organization. As another example, if the network is a software-as-a-service (“SaaS”), platform-as-a-service (“PaaS”), or infrastructure-as-a-service (“IaaS”) cloud computing system, then the intrusion detection system 110 can be a component of the SaaS, PaaS, or IaaS cloud computing system.

In some other implementations, the intrusion detection system 110 can be maintained by a different entity than the network. For example, a network security organization can provide the intrusion detection system 110 as a product or as a service to the entity that maintains the network.

As described above, the intrusion detection system 110 is configured to process a data object 102 “on the wire,” i.e., as the data object 102 is entering the network from an external system that is communicatively connected to the network, e.g., through the internet. The data object 102 is composed of a sequence of multiple data packets that are passing through the wire. In this specification, a data packet is any piece of data communicated over a network that partially or wholly represents a data object. A data packet can have any appropriate size and configuration. For example, a data object can be represented by a sequence of Transmission Control Protocol (TCP) packets. As another example, a data object can be represented by a sequence of bits or bytes.

The intrusion detection system 110 is configured to process the sequence of data packets as they enter the network to determine whether the data object 102 is malicious. In particular, the intrusion detection system 110 can reconstruct the sequence of data packets to generate a sequence of stream objects representing the data object 102. That is, each stream object can be generated from a subsequence of the data packets. In this specification, a stream object is any sequence of bytes representing some or all of a data object that is generated by reassembling data packets of the data object. The intrusion detection system can then iteratively analyze a sliding window of one or more of the stream objects of the data object 102 to determine whether the data object 102 is malicious.

The intrusion detection system 110 includes an IDS signature library 120 that includes one or more IDS signatures. In this specification, an IDS signature is a function that can be applied to a sequence of one or more stream objects representing a data object to determine whether the data object is malicious. An IDS signature can generate an output that is either positive (i.e., the sequence of one or more stream objects “matches” the signature) or negative (i.e., the sequence of one or more stream objects does not match the signature). Examples IDS signatures are discussed in more detail below.

An IDS signature is typically generated using a data object that is known to be malicious, and defines a pattern exhibited by the malicious data object. If another data object matches the signature, then the other data object shares the defined pattern of the malicious data object. Thus, the intrusion detection system 110 can determine that if the data object 102 matches one or more IDS signatures (corresponding to respective patterns of known malicious data objects) in the IDS signature library 120, then the data object 102 is likely to be malicious as well.

The intrusion detection system 110 can apply each IDS signature in the IDS signature library 120 to the sequence of stream objects of the data object 102. As an illustrative example, if the data object 102 includes five stream objects and a particular IDS signature in the IDS signature library 120 is configured to be applied to a sequence of three stream objects, then as the sequence of data packets of the data object 102 is downloaded by the network and reconstructed into the sequence of stream objects, the intrusion detection system 110 can apply the particular IDS signature to stream objects 1-3, then to stream objects 2-4, then to stream objects 3-5. Generally, a data object can have significantly more than five stream objects, e.g., hundreds, thousands, or millions of stream objects. In some implementations, each IDS signature in the IDS signature library 120 is applied to only a single stream object at a time.

As is described in more detail below, the data object 102 can include multiple different components, where each component is represented by a respective different subsequence of the sequence of data packets of the data object. Each component can then be represented in a sequence of one or more reconstructed stream objects. In some implementations, each component is only included in a single stream object of the data object 102; that is, the representation of a single component cannot be spread across multiple different stream objects.

Each IDS signature can be applied to a different-sized sliding window of stream objects. For example, one or more IDS signatures in the library 120 can be applied to a window of 100 bytes of a sequence of bytes representing the data object 102, while other IDS signatures in the library 120 can be applied to a window of 5000 bytes of the sequence of bytes representing the data object 102, while yet other IDS signatures in the library 120 can be applied to a window of 1M bytes of the sequence of bytes representing the data object 102. The IDS signature library 120 can include any appropriate number of IDS signatures, e.g., thousands, tens of thousands, hundreds of thousands, millions, or tens of millions of IDS signatures.

The data object 102 can include any appropriate type of data. For example, the data object 102 can include a computer program. As a particular example, the data object 102 can include a compiled executable program written in a computer-readable language, e.g., a binary file. As another example, the data object 102 can include a script written in a human-readable programming language. Example data objects are discussed in more detail below.

In some implementations, if the data object 102 matches any of the IDS signatures in the IDS signature library 120, then the intrusion detection system 110 determines the data object to be malicious. In some other implementations, the intrusion detection system 110 requires the data object 102 to match multiple different IDS signatures in the IDS signature library 120 to be considered malicious. For example, the intrusion detection system 110 can determine the data object 102 to be malicious if the data object 102 matches a predetermined threshold number of IDS signatures or a predetermined threshold proportion of IDS signatures in the IDS signature library 120.

In response to identifying the data object 102 as malicious, the intrusion detection system 110 can take one or more actions; for example, the intrusion detection system 110 can send an alert to a user of the network or another entity of the network. More example actions are described in more detail below.

If the data object 102 satisfies one or more criteria, the intrusion detection system 110 can send the entire data object 102 (i.e., as opposed to a stream of data packets or stream objects as described above) to the code reuse analysis system 130. For example, the intrusion detection system 110 can send the data object 102 to the code reuse analysis system 130 if the data object matches one or more IDS signatures in the IDS signature library 120.

As another example, the intrusion detection system 110 can send every data object 102 received during a period of time to the code reuse analysis system 130. As a particular example, when the intrusion detection system 110 is first installed on the network, the intrusion detection system 110 can send each received data object 102 to the code reuse analysis system 130, which is configured to automatically generate new IDS signatures 132 from the data objects 102 (as is described in more detail below). Then, after the code reuse analysis system 130 has added new IDS signatures 132 to the IDS signature library 120, the intrusion detection system 110 can stop sending every received data object 102 to the code reuse analysis system (and, e.g., only send data objects 102 to the code reuse analysis system if the data object 102 satisfies one or more criteria, as described above). For example, the intrusion detection system 110 can determine to stop sending every data object 102 to the code reuse analysis system 130 after a predetermined period of time has passed, or after a predetermined number of new IDS signatures 132 have been added to the IDS signature library 120.

As another example, the intrusion detection system 110 can send every data object 102 of a predetermined type to the code reuse analysis system 130. As a particular example, the intrusion detection system 110 can send every data object 102 that is an executable file to the code reuse analysis system.

As another example, the intrusion detection system 110 can send every data object 102 that does not come from a trusted source to the code reuse analysis system 130. As a particular example, the intrusion detection system 110 can maintain a list of trusted sources, and only send the data object 102 to the code reuse analysis system 130 if the data object 102 does not include a signature from a trusted source from the list, e.g., a signature generated using a cryptographic hash that guarantees the authenticity of the data object 102.

In some implementations, the code reuse analysis system 130 can receive data objects 102 from other entities of the network other than the intrusion detection system 110. For example, if the data object 102 is determined to be malicious after the data object 102 has entered the network, then a user of the network or another system in the network can send the data object 102 to the code reuse analysis system 130. In this example, the intrusion detection system 110 has failed to identify the data object 102 as malicious because none of the IDS signatures in the IDS signature library 120 matched the data object 102. Therefore, to avoid allowing another malicious data object that is similar or identical to the malicious data object 102 into the network, the code reuse analysis system 130 can automatically generate a new IDS signature 132 that does match the malicious data object 102, and add the new IDS signature to the IDS signature library 120.

The code reuse analysis system 130 includes a malware detection system 140, a component tracking system 150, and an automatic IDS signature generation system 160.

The malware detection system 140 is configured to process the data object 102 to determine whether the data object 102 is malicious. Typically, the malware detection system 140 uses different techniques than the intrusion detection system 110 to determine whether the data object 102 is malicious; that is, the malware detection system 140 does not apply the IDS signatures in the IDS signature library 120 to the data object 102. For example, if the data object 102 includes a computer program, then then malware detection system 140 can execute the computer program in an isolated, secure environment (sometimes called a “sandbox”) to observe the behavior of the computer program. For instance, the computer program can be executed for a predetermined amount of time (e.g., 30 seconds or 10 minutes) to identify the behavior of the computer program.

After processing the data object 102, the malware detection system 140 can classify the data object 102 as malicious or not malicious. In this specification, a data object that has been determined not to be malicious is sometimes called “benign.” In some implementations, the data object 102 can classify the data object 102 as malicious, benign, or “inconclusive,” where the data object 102 is determined to be inconclusive if the malware detection system 140 cannot, with a high enough confidence, classify the data object 102 as either malicious or benign.

As a particular example, in some implementations, the malware detection system 130 only classifies a data object 102 as benign if the data object 102 is known to have been generated by a trusted source, e.g., an established software company. For instance, the malware detection system 140 can maintain a list of trusted sources, and only classify the data object 102 as benign if the data object includes a signature from a trusted source from the list, e.g., a signature generated using a cryptographic hash that guarantees the authenticity of the data object 102. If the data object 102 does not exhibit any malicious behavior when processed by the malware detection system 140, but is not known to originate from a trusted source, then the malware detection system 140 can classify the data object 102 as inconclusive.

In some implementations, the malware detection system 140 does not process the data object 102 to determine whether the data object 102 is malicious because the data object 102 is already known to be malicious. For example, as described above, an entity of the network can send the data object 102 to the code reuse analysis system 130 in response to determining that the data object 102 is malicious but was not identified as malicious by the intrusion detection system 110.

The malware detection system 140 is further configured to disassemble the data object 102 into multiple different components 142. The malware detection system 140 can disassemble the data object 102 regardless of whether the data object 102 is classified as malicious, benign, or inconclusive. For example, in some implementations, the malware detection system 140 disassembles the data object 102 during the process of determining whether the data object 102 is malicious, and uses the determined components 142 of the data object 102 to classify the data object 102.

In this specification, a component of a data object is any proper subset of the data of the data object, e.g., any proper subset of the bits that represent the data object 102. For example, a component can be represented by a subsequence of the sequence of data packets or stream objects of the data object.

For example, if the data object 102 includes human-readable computer code (i.e., code written in a human-readable programming language) and/or computer-readable computer code (i.e., code written in a programming language that is not human-readable), then the components of the data object 102 can include portions of the code. If the data object 102 is malicious, then the components of the data object 102 can include portions of the code that are reused by multiple different malicious developers, as described in more detail below.

As a particular example, if the data object 102 includes a binary executable file for a computer program, the malware detection system 140 can disassemble the executable file into multiple different functions. The malware detection system 140 can use any appropriate technique to disassemble the executable file.

For instance, the malware detection system 140 can perform a file structure analysis to determine the location of the computer code, the data used by the computer program, and/or entry points of the computer program. Instead or in addition, the malware detection system 140 can disassemble the binary executable file to determine a set of CPU instructions. Instead or in addition, the malware detection system can reconstruct a call graph of the functions of the computer program, e.g., including functions that are statically linked inside the data object 102 and functions that are to be dynamically resolved by the operating system of the device that executes the computer program. Instead or in addition, the malware detection system 140 can determine a start address and an end address for each function in the computer program.

As another particular example, if the data object 102 includes a computer script written in a human-readable programming language, the malware detection system 140 can disassemble the script into multiple different features, e.g., variable names, function names, URL addresses, strings, operations, code functions, file section names, import tables, export tables, and so on.

In some implementations, the malware detection system 140 is further configured to determine, for each component 142 of the data object 102, portions of the component 142 that are unstable. In this specification, a portion of a component of a data object is any proper subset of the data of the component of the data object, e.g., any proper subset of the bits that represent the data object 102. In this specification, a portion of a component of a data object is unstable if the portion is likely to change between versions of the component included in respective different data objects.

As described above, malicious developers often make superficial changes to a component while keeping the rest of the component (e.g., the core functionality of the component) the same. That is, the malicious developers often reuse code. Furthermore, the same computer program can have different parameters when loaded in different locations in memory (e.g., references to specific memory addresses can change, even if the computer program is functionally identical). To track the frequency with which a component 142 is identified in data objects received by the code reuse analysis system 142 (as is described in more detail below), the code reuse analysis system 130 can update the component 142 to remove the unstable portions of the component 142 that are likely to change, such that the updated component 142 can be tracked across multiple different data objects even when superficially changed.

As a particular example, if the component 142 is a component of a computer program, then the malware detection system 140 can identify one or more portions of the component that can be easily modified without changing the functionality of the component. For example, the unstable portions of the computer program can include one or more of: one or more variable names referenced in the component, one or more virtual memory addresses referenced in the component, one or more subroutine names referenced in the component, one or more variable constants, and so on.

For example, the malware detection system 140 can maintain a list of rules for determining the unstable portions of a component 142. As a particular example, the malware detection system 140 inspect each assembly instruction of a set of assembly instructions of a computer program one at a time, and determine whether the assembly instruction, or parts of the assembly instruction, satisfy one or more predetermined instability conditions.

After identifying the unstable portions of a component 142, the malware detection system 140 can process the component 142 of the data object 102 to remove the identified unstable portions. For example, the malware detection system 140 can generate a bitmask for the component 142 that masks the identified unstable portions from the component 142. The bitmask can include a respective bit for each portion of the component 142, e.g., a respective bit for each bit of the component 142, each byte of the component 142, each half word (i.e., each set of two bytes) of the component 142, or each word (i.e., each set of four bytes) of the component 142. Each bit of the bitmask corresponding to a portion of the component 142 that has been identified as unstable can have a value of ‘0’, while each bit of the bitmask corresponding to a portion of the component 142 that has not been identified as unstable can have a value of ‘1’.

Thus, by processing the component 142 using the bitmask, the malware detection system 140 can generate a masked component 142 that represents the core functionality of the component, such that the masked component 142 can be identified across multiple different data objects 102. In some implementations, as described in more detail below, the portions of the component 142 that are masked by the bitmask are replaced by a special character that indicates that the portion may include any data and still match the component 142.

The malware detection system 140 can provide data identifying the components 142 of the data object 102 to the component tracking system 150, as well as data identifying the classification of the data object 102.

The malware detection system 140 can provide any appropriate data that identifies the components 142 to the component tracking system 150. For example, the malware detection system 140 can process each component 142 of the data object 102 using a hash function to generate an identifier for the component 142, and provide the generated identifier to the component tracking system 150. In implementations in which the malware detection system 140 is configured to remove unstable portions of the component 142 to generate an updated component 142, the malware detection system 140 can process the updated component 142 using the hash function to generate the identifier. As a particular example, the malware detection system 140 can first process the component 142 using a bitmask to generate a masked component 142, as described above, and then process the masked component 142 using the hash function to generate the identifier.

In some implementations, in which the malware detection system 140 removes the unstable portions of the components 142 to generate respective masked components 142, the malware detection system 140 can further provide the masked components 142 themselves to the component tracking system. For example, the malware detection system 140 can replace each portion (e.g., each bit, each byte, each half word, or each word) of the components 142 that is unstable with a predetermined special character, e.g., a “??” character.

The component tracking system 150 is configured to maintain data tracking, for each component 142 of each data object 102 analyzed by the code reuse analysis system 130: (i) how often the component 142 has been identified in a data object 102 classified as malicious and (ii) how often the component 142 has been identified in a data object 102 classified as benign. In implementations in which the malware detection system 140 also classifies data objects 102 as inconclusive, the component tracking system 150 can also maintain data tracking, for each component 142 of each data object 102 analyzed by the code reuse analysis system: (iii) how often the component 142 has been identified in a data object 102 classified as inconclusive.

As described above, different malicious data objects 102 often include the same components 142. By tracking the historical frequencies with which components 142 are observed in malicious and benign data objects 102, the code reuse analysis system 130 can identify the components 142 that, when observed in a new data object 102, indicate that the data object 102 is likely to be malicious. The code reuse analysis system 130 can then generate new IDS rules 132 using the identified components.

After receiving the data identifying the components 142 and the classification of the data object 102 from the malware detection system 140, the component tracking system 150 can update the tracking data corresponding to the components 142 to reflect the fact that the components 142 have been observed in the data object 102.

For example, the component tracking system 150 can maintain a table, called a “component tracking table” herein, that includes a respective entry for each component 142 observed by the code reuse analysis system 130.

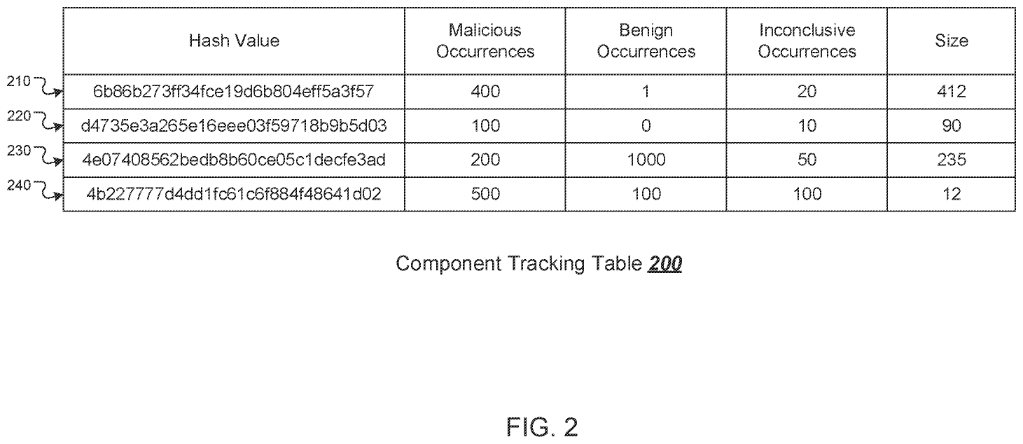

FIG. 2 is an illustration of an example component tracking table 200. The component tracking table 200 can be maintained by a component tracking system of a code reuse analysis system, e.g., the component tracking system 150 of the code reuse analysis system 130 depicted in FIG. 1.

Each row of the component tracking table 200 corresponds to a respective different component of a respective data object observed by a code reuse analysis system. Each component can be identified in any appropriate way. For example, as illustrated in FIG. 2, each component can be identified by a hash value generated by processing the component using a hash function, e.g., a Message Digest (MD) hash function or a Secure Hashing Algorithm (SHA) hash function. As described above, in some implementations before processing a component using the hash function, the code reuse analysis system can remove unstable portions of the component, e.g., by processing the component using a binary mask.

The row of the component tracking table 200 corresponding to each component identifies (i) a number of times the component has been observed in data objects determined to be malicious, (ii) a number of times the component has been observed in data objects determined to be benign, and (iii) a number of times the component has been observed in data objects determined to be inconclusive.

Each time the code reuse analysis system analyzes a new data object, the code reuse analysis system can classify the new data object as malicious, benign, or inconclusive, and identify multiple components of the data object. For each identified component of the new data object, the component tracking system can determine whether the component is already included in the component tracking table 200 (i.e., whether the component has previously been observed in a different data object). If so, the component tracking system can increment the counter of the component corresponding to the classification of the new data object. That is, if the new data object has been classified as malicious, then the component tracking system can increment the “malicious occurrences” counter of the component by one; if the new data object has been classified as benign, then the component tracking system can increment the “benign occurrences” counter of the component by one; and if the new data object has been classified as inconclusive, then the component tracking system can increment the “inconclusive occurrences” counter of the component by one.

If the code reuse analysis system has not observed a particular component previously (i.e., if the hash value of the particular component is not already present in the component tracking table 200), then the component tracking system can add an entry to the component tracking table 200 for the particular component, and establish the counter corresponding to the classification of the new data object to be one, and establish all other counters to be zero.

In some implementations, the component tracking system does not track “inconclusive” occurrences; that is, in some implementations, the component tracking table 200 only includes “malicious occurrences” and “benign occurrences” entries for each component.

Although the component tracking table 200 of FIG. 2 maintains data tracking raw counts of occurrences for each observed component, generally a component tracking table can maintain any appropriate data that characterizes a frequency with which each component has been observed in respective types of data objects. For example, a component tracking table can maintain data identifying, for each component, (i) a proportion of malicious data objects the component has been observed in (e.g., 5% of all malicious data objects observed by the code reuse analysis system), (ii) a proportion of benign data objects the component has been observed in, and (iii) a proportion of inconclusive data objects the component has been observed in.

In some implementations, the component tracking table 200 also identifies, for each component represented by the table 200, a size of the component, e.g., the number of bytes of the component or the number of instructions in the component (e.g., if the component represents a function of a computer program). The size of a component can be used to generate an IDS signature using the component. This process is described in more detail below.

In some implementations, the component tracking table 200 also identifies, for each component represented by the table 200, one or more of: a number of times the component has been observed in a signed data object, a number of times the component has been observed in a data object from an allow or deny list, a most recent time that the component was observed, a most common class or family of malicious data objects that the component has been observed in, and so on.

Referring back to FIG. 1, the automatic IDS signature generation system 160 is configured to automatically generate new IDS signatures 132. The automatic IDS signature generation system 160 can use the tracking data maintained by the component tracking system 150 to generate the new IDS signatures 132.

In some implementations, the automatic IDS signature generation system 160 can determine to generate a new IDS signature 132 corresponding to a particular component 142 tracked by the component tracking system 140, when the particular component 142 satisfies one or more criteria.

As a particular example, the automatic IDS signature generation system 160 can determine to generate a new IDS signature 132 when the number of times that the particular component 142 has been observed in a malicious data object 102 exceeds a predetermined threshold. For instance, referring to FIG. 2, if the predetermined threshold is 400 malicious occurrences, then the automatic IDS signature generation system 160 can determine to generate a new IDS signature 132 corresponding to the component represented in the first row 210 of the component tracking table 200.

As another particular example, the automatic IDS signature generation system 160 can determine to generate a new IDS signature 132 when (i) the number of times that the particular component 142 has been observed in a malicious data object 102 exceeds a first predetermined threshold, and (ii) the number of times that the particular component 142 has been observed in a benign data object 102 is below a second predetermined threshold. For instance, referring to FIG. 2, although the component represented in the fourth row 240 of the component tracking table 200 has been observed in 500 malicious data objects, the component has also been observed in 100 benign data objects. Thus, if the second predetermined threshold is below 100 benign occurrences, then the automatic IDS signature generation system 160 can determine not to generate a new IDS signature 132 for the component represented in the fourth row 240 of the component tracking table 200. In some implementations, the second predetermined threshold is zero—that is, the particular component 142 must not have been observed in any benign data object 102 for a new IDS signature 132 to be generated from the particular component 142. Such a configuration can be useful to minimize false positives generated by the intrusion detection system 110, e.g., in environment in which a false positive (i.e., a benign data object 102 that is identified as malicious) can have severe consequences.

As another particular example, the automatic IDS signature generation system 160 can determine to generate a new IDS signature 132 when (i) the total number of times that the particular component 142 has been observed in any data object 102 exceeds a first predetermined threshold, and (ii) the number or proportion of times that the particular component 142 was observed in a malicious data object 102 exceeds a second predetermined threshold. For instance, referring to FIG. 2, the component represented in the first row 210 of the component tracking table 200 has been observed 421 total times, with approximately 95% of the observations coming from malicious data objects; if these two values satisfy the two respective thresholds, then the automatic IDS signature generation system 160 can determine to generate a new IDS signature 132 for the component represented in the first row 210. Alternatively, while the component represented in the third row 230 has been observed in 200 malicious data objects, only approximately 16% of the observations came from malicious data objects. Thus, if the second predetermined threshold is below 0.16, then the automatic IDS signature generation system 160 can determine not to generate a new IDS signature 132 for the component represented in the third row 230 of the component tracking table 200.

As another particular example, the automatic IDS signature generation system 160 can determine to generate a new IDS signature 132 when (i) the total number of times that the particular component 142 has been observed in any data object 102 exceeds a first predetermined threshold, (ii) the number or proportion of times that the particular component 142 was observed in a malicious data object 102 satisfies a exceeds predetermined threshold, and (iii) the number or proportion of times that the particular component 142 was observed in a benign data object 102 is below a third predetermined threshold.

As described above, an IDS signature defines a pattern exhibited by the malicious data object, e.g., a pattern exhibited by one or more components of the malicious data object. Given a component 142, the automatic IDS signature generation system 160 can use the component 142 to generate an IDS signature 132 that will match any data object that includes the component 142.

For example, the IDS signature 142 can be the component 142 itself, or the masked version of the component 142 described above. That is, the IDS signature 132 can be the same as the component 142 itself, with the unstable portions of the component 142 identified by the code reuse analysis system 130 removed, e.g., by being replaced with a special token. In other words, the special token indicates that a data object can include any data in the location corresponding to the special token and still match the IDS signature 142. As a particular example, the masked version of the component 142 (and/or the component 142 itself) can be stored by the component tracking system 150 and obtained by the automatic IDS signature generation system 160.

In some implementations, the automatic IDS signature generation system 160 can generate a single IDS signature 132 corresponding to multiple different components 142. For example, the IDS signature 132 can include a respective signature corresponding to each of the multiple different components 142, and the IDS signature 132 can be considered to match a data object if the data object matches each respective signature corresponding to the multiple different components 142. That is, the intrusion detection system 110 can apply each respective signature corresponding to the multiple different components 142 in parallel. In some such implementations, each component 142 in the same IDS signature 132 must have been observed in the same malicious data object, e.g., a malicious data object sent to the code reuse analysis system 130 as described above.

In some such implementations, the automatic IDS signature generation system 160 can require the components 142 corresponding to a new signature 132 to have, cumulatively, at least a threshold size. That is, the sum of the sizes of the components 142 used to generate a new signature 132 must exceed a predetermined threshold. For example, the automatic IDS signature generations system 160 can require a minimum number of instructions to be cumulatively represented by the components 142. This requirement can help ensure the reliability of the new IDS signature 132; if the new IDS signature 132 only represented a few instructions, then the new IDS signature 132 may be susceptible to false positives.

For instance, referring to FIG. 2, if the minimum number of instructions required to generate a new IDS signature 132 is 500 instructions, then the automatic IDS signature generation system 160 can determine that the component represented in the second row 220 of the component tracking table 200 is too small to generate a new IDS signature 132 corresponding to only that component (even if the component satisfies all other requirements for generating an IDS signature, e.g., has greater than a threshold number of malicious occurrences). However, the automatic IDS signature generation system 160 can determine that the respective components represented by the first row 210 and the second row 220 cumulatively have greater than the required 500 instructions, and thus can generate a new IDS signature 132 corresponding to those two components.

In some implementations, the automatic IDS signature generation system 160 can determine to generate a new IDS signature 132 corresponding to one or more components 142 of a known malicious data object. For example, the code reuse analysis system 130 can receive the known malicious data object and determine whether one or more IDS signatures in the IDS signature library 120 match the known malicious data object. If the code reuse analysis system 130 determines that no such IDS signature is in the library 120 (e.g., if the malicious data object was not identified by the intrusion detection system 110 but was subsequently identified as malicious by another entity of the network, as described above), then the automatic IDS signature generation system 160 can generate a new IDS signature 132 corresponding to one or more components of the malicious data object, to ensure that future malicious data objects having similar components are identified by the intrusion detection system 110.

As a particular example, the automatic IDS signature generation system 160 can identify, for each component 142 of a known malicious data object, the entry of the component 142 in the component tracking table of the component tracking system 150. For each identified component 142, the automatic IDS signature generation system 160 can determine whether the component 142 satisfies one or more predetermined conditions for inclusion in a new ID signature 132 (e.g., the conditions described above). The automatic IDS signature generation system 160 can then determine whether the number of components 142 that satisfy the predetermined conditions exceeds a first predetermined threshold. Instead or in addition, the automatic IDS signature generation system 160 can determine whether the cumulative size of the components 142 that satisfy the predetermined conditions exceeds a second predetermined threshold.

If so, the automatic IDS signature generation system 160 can generate a new IDS signature 132 using some or all of the components 142 that satisfy the predetermined conditions. For example, the automatic IDS signature generation system 160 can generate a new IDS signature 132 using each component 142 that satisfies the predetermined conditions. As another example, the automatic IDS signature generation system 160 can generate a new IDS signature 132 using the top N components 142 that satisfy the predetermined conditions, N≥1. For instance, the automatic IDS signature generation system 160 can use the N components 142 with the highest malicious occurrence counts.

After generating the new IDS signature 132, the code reuse analysis system 130 can provide the new IDS signature 132 to the intrusion detection system 130. The intrusion detection system 130 can add the new IDS signature 132 to the IDS signature library 120, and apply the IDS signature 132 to future data objects 102 analyzed by the intrusion detection system 110.

In some implementations, the intrusion detection system 110 is also an intrusion prevention system that is configured to take an action if the data object 102 is determined to be malicious. For example, if the intrusion detection system 110 determines a data object 102 to be malicious, the intrusion detection system 110 can reject the data object 102, i.e., not allow the data object 102 to be downloaded by the network. As another example, if the intrusion detection system 110 determines the data object 102 to be malicious, the intrusion detection system 110 can kill the communicative connection between the network and the external system that is sending the data object 102. In some other implementations, the intrusion detection system 110 can be configured to allow a data object 102 to enter the network even if the data object 102 is determined to be malicious.

In some implementations, the intrusion detection system 110 can send an alert to a user of the network or another entity of the network in response to determining that a data object 102 is malicious. In some such situations, the alert can identify a particular malicious behavior that the data object 102 exhibits or is predicted to exhibit.

For example, when processing a malicious data object in the sandbox, as described above, the malware detection system 140 can determine a malicious behavior that the data object exhibits. When the code reuse analysis system 130 generates a new IDS signature 132 corresponding to one or more components of the malicious data object and provide the new IDS signature 132 to the intrusion detection system 110, the code reuse analysis system 130 can further provide data identifying the malicious behavior exhibited by the malicious data object to the intrusion detection system 110. Then, when the new IDS signature 132 matches a new data object 102, the intrusion detection system 110 can determine that the new data object 102 is likely to exhibit the same malicious behavior as the malicious data object from which the new IDS signature 132 was generated.

In some implementations, the intrusion detection system 110 can collect data characterizing how often each IDS signature in the IDS signature library 120 matches a data object 102. For example, the intrusion detection system 110 can collect such data to avoid false positives. If the intrusion detection system 110 identifies that a particular IDS signature matches data objects that subsequently are determined to be benign (e.g., by the malware detection system 140), then the intrusion detection system 110 can determine that the particular IDS signature is susceptible to false positives and remove it from the IDS signature library 120. As a particular example, each time a new IDS signature is added to the IDS signature library 120, then intrusion detection system 110 can track data related to the new IDS signature for a period of time to ensure that the new IDS signature is properly configured.

In some implementations, the intrusion detection system 110 operates without the code reuse analysis system 130. That is, the system 100 does not include the code reuse analysis system. For example, the intrusion detection system 110 can obtain the library 120 of IDS signatures from an external source. As a particular example, the entity that maintains the network can obtain the IDS signatures in the library 120 from a different entity, e.g., from an entity that generated the IDS signatures using the techniques described above.

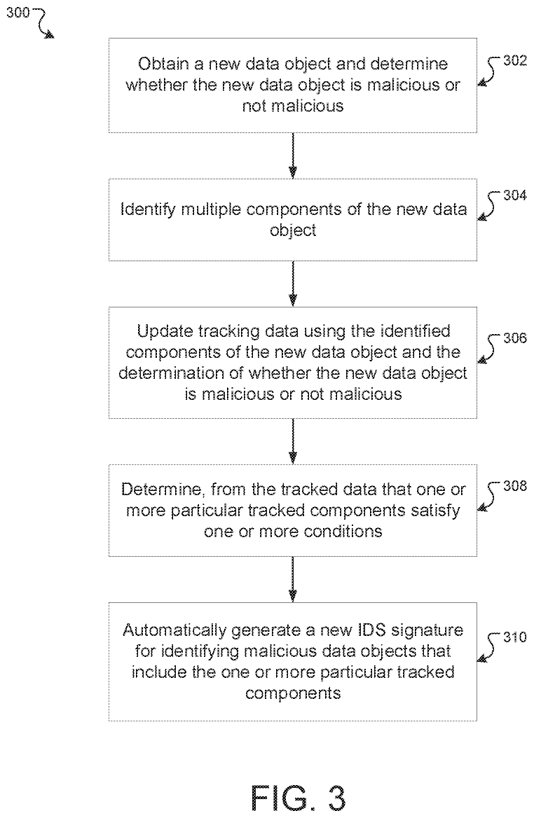

FIG. 3 is a flow diagram of an example process 300 for automatically generating an IDS signature. For convenience, the process 300 will be described as being performed by a system of one or more computers located in one or more locations. For example, a system that includes an intrusion detection system, e.g., the system 100 depicted in FIG. 1, appropriately programmed in accordance with this specification, can perform the process 300.

The system obtains a new data object and determines whether the new data object is malicious or not malicious (step 302).

The system identifies multiple components of the new data object (step 304).

The system updates tracking data using (i) the identified components of the new data object and (ii) the determination of whether the new data object is malicious or not malicious (step 306). The tracking data can identify, for each of multiple tracked components of previous data objects, (i) a frequency with which the tracked component has been identified in previous data objects determined to be malicious and (ii) a frequency with which the tracked component has been identified in previous data objects determined not to be malicious. In some implementations, the tracking data also includes, for each of the multiple tracked components, a frequency with which the tracked component has been identified in data objects whose maliciousness has been determined to be inconclusive.

In some implementations, the system can determine, for each of one or more identified components of the new data object, one or more portions of the identified component that are unstable. The system can then remove, for each of the one or more identified components, the unstable portions of the identified component to generate a respective masked component, and update the tracking data using the one or more generated masked components.

The system determines, from the tracked data, that one or more particular tracked components satisfy one or more conditions (step 308).

For example, if the new data object has been determined to be malicious, then the system can determine that the new data object does not match any existing IDS signature in a library of IDS signatures. That is, the new data object would not be properly identified as malicious using the existing library of IDS signatures. Thus, the system can select, from the multiple identified components of the new data object, the one or more particular tracked components to use to generate the new IDS signature.

Instead or in addition, the system can determine, for each of the one or more particular tracked components and from the tracking data, that the frequency with which the particular tracked component has been identified in previous data objects determined to be malicious exceeds a first predetermined threshold.

Instead or in addition, the system can determine, for each of the one or more particular tracked components and from the tracking data, that the frequency with which the particular tracked component has been identified in previous data objects determined not to be malicious is below a second predetermined threshold.

Instead or in addition, the system can identify, for each of the one or more particular tracked components, a respective size of the particular tracked component. The system can then determine whether the sum of the sizes of the one or more particular tracked components satisfies a third predetermined threshold.

In response to the determination, the system automatically generates a new IDS signature for identifying malicious data objects that include the one or more particular tracked components (step 310).

After generating the new IDS signature, the system can apply the new IDS signature to a second data object.

In some implementations, if the system determines that the second data object matches the new IDS signature, the system can send, e.g., to a user of the system, an alert that identifies a predicted behavior of the second data object. The predicted behavior can be determined according to a behavior of one or more malicious data objects whose components were used to generate the new IDS signature (e.g., the new data object).

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; solid state drives, NVMe devices, persistent memory devices, magnetic disks, e.g., internal hard disks or removable disks; magneto-optical disks; and CD-ROM and DVD-ROM and Blu-ray discs. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g, a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communications network. Examples of communications networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method comprising:

obtaining a new data object and determining whether the new data object is malicious or not malicious;

identifying a plurality of components of the new data object;

updating tracking data using (i) the identified plurality of components of the new data object and (ii) the determination of whether the new data object is malicious or not malicious,
wherein the tracking data identifies, for each of a plurality of tracked components of previous data objects, (i) a frequency with which the tracked component has been identified in previous data objects determined to be malicious and (ii) a frequency with which the tracked component has been identified in previous data objects determined not to be malicious; and

determining, from the tracking data, that one or more particular tracked components satisfy one or more conditions and, in response:
automatically generating a new intrusion detection system (IDS) signature for identifying malicious data objects that include the one or more particular tracked components.

Embodiment 2 is the method of embodiment 1, wherein determining that one or more particular tracked components satisfy one or more conditions comprises:

in response to determining that the new data object is malicious:
determining that the new data object does not match any existing IDS signatures in a library of IDS signatures; and
selecting, from the identified plurality of components of the new data object, the one or more particular tracked components.

Embodiment 3 is the method of any one of embodiments 1 or 2, wherein determining that one or more particular tracked components satisfy one or more conditions comprises one or more of:

determining, for each of the one or more particular tracked components and from the tracking data, that the frequency with which the particular tracked component has been identified in previous data objects determined to be malicious exceeds a first predetermined threshold;

determining, for each of the one or more particular tracked components and from the tracking data, that the frequency with which the particular tracked component has been identified in previous data objects determined not to be malicious is below a second predetermined threshold; or

identifying, for each of the one or more particular tracked components, a respective size of the particular tracked component and determining that a sum of the sizes of the one or more particular tracked components satisfies a third predetermined threshold.

Embodiment 4 is the method of any one of embodiments 1-3, wherein updating the tracking data comprises:

determining, for each of one or more identified components of the new data object, one or more portions of the identified component that are unstable;

removing, for each of the one or more identified components, the unstable portions of the identified component to generate a respective masked component; and

updating the tracking data using the one or more generated masked components.

Embodiment 5 is the method of any one of embodiments 1-4, wherein the tracking data further identifies, for each of the plurality of tracked components, a frequency with which the tracked component has been identified in data objects whose maliciousness has been determined to be inconclusive.

Embodiment 6 is the method of any one of embodiments 1-5, further comprising applying, by an intrusion detection system of a network, the new IDS signature to a second data object as the second data object is entering the network.

Embodiment 7 is the method of embodiment 6, further comprising:

determining that the second data object matches the new IDS signature; and

in response, sending, to a user of the network, an alert that identifies a predicted behavior of the second data object, wherein the predicted behavior is determined according to a behavior of a malicious data object whose components were used to generate the new IDS signature.

Embodiment 8 is a system comprising one or more computers and one or more storage devices storing instructions that are operable, when executed by the one or more computers, to cause the one or more computers to perform the method of any one of embodiments 1 to 7.

Embodiment 9 is one or more non-transitory computer storage media encoded with a computer program, the program comprising instructions that are operable, when executed by data processing apparatus, to cause the data processing apparatus to perform the method of any one of embodiments 1 to 7.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. For example, the subject matter is described in context of scientific papers. The subject matter can apply to other indexed work that adds depth aspect to a search. In some cases, the actions recited in the claims can be performed in a different order and still achieve desirable results. In addition, the processes described do not necessarily require the particular order shown, or sequential order, to achieve desirable results. In certain implementations, multitasking and parallel processing can be advantageous.

What is claimed is:

1. A method comprising:
obtaining a new data object and determining whether the new data object is malicious or not malicious;
identifying a plurality of components of the new data object;
updating tracking data using (i) the identified plurality of components of the new data object and (ii) the determination of whether the new data object is malicious or not malicious,
wherein the tracking data identifies, for each of a plurality of tracked components of previous data objects, (i) a frequency with which the tracked component has been identified in previous data objects determined to be malicious and (ii) a frequency with which the tracked component has been identified in previous data objects determined not to be malicious; and
determining, from the tracking data, that one or more particular tracked components satisfy one or more conditions and, in response:
automatically generating a new intrusion detection system (IDS) signature for identifying malicious data objects that include the one or more particular tracked components.

2. The method of claim 1, wherein determining that one or more particular tracked components satisfy one or more conditions comprises:
in response to determining that the new data object is malicious:
determining that the new data object does not match any existing IDS signatures in a library of IDS signatures; and
selecting, from the identified plurality of components of the new data object, the one or more particular tracked components.

3. The method of claim 1, wherein determining that one or more particular tracked components satisfy one or more conditions comprises one or more of:
determining, for each of the one or more particular tracked components and from the tracking data, that the frequency with which the particular tracked component has been identified in previous data objects determined to be malicious exceeds a first predetermined threshold;
determining, for each of the one or more particular tracked components and from the tracking data, that the frequency with which the particular tracked component has been identified in previous data objects determined not to be malicious is below a second predetermined threshold; or
identifying, for each of the one or more particular tracked components, a respective size of the particular tracked component and determining that a sum of the sizes of the one or more particular tracked components satisfies a third predetermined threshold.

4. The method of claim 1, wherein updating the tracking data comprises:
determining, for each of one or more identified components of the new data object, one or more portions of the identified component that are unstable;
removing, for each of the one or more identified components, the unstable portions of the identified component to generate a respective masked component; and
updating the tracking data using the one or more generated masked components.

5. The method of claim 1, wherein the tracking data further identifies, for each of the plurality of tracked components, a frequency with which the tracked component has been identified in data objects whose maliciousness has been determined to be inconclusive.

6. The method of claim 1, further comprising applying, by an intrusion detection system of a network, the new IDS signature to a second data object as the second data object is entering the network.

7. The method of claim 6, further comprising:
determining that the second data object matches the new IDS signature; and
in response, sending, to a user of the network, an alert that identifies a predicted behavior of the second data object, wherein the predicted behavior is determined according to a behavior of a malicious data object whose components were used to generate the new IDS signature.

8. A system comprising one or more computers and one or more storage devices storing instructions that are operable, when executed by the one or more computers, to cause the one or more computers to perform operations comprising:
obtaining a new data object and determining whether the new data object is malicious or not malicious;
identifying a plurality of components of the new data object;
updating tracking data using (i) the identified plurality of components of the new data object and (ii) the determination of whether the new data object is malicious or not malicious,
wherein the tracking data identifies, for each of a plurality of tracked components of previous data objects, (i) a frequency with which the tracked component has been identified in previous data objects determined to be malicious and (ii) a frequency with which the tracked component has been identified in previous data objects determined not to be malicious; and
determining, from the tracking data, that one or more particular tracked components satisfy one or more conditions and, in response:
automatically generating a new intrusion detection system (IDS) signature for identifying malicious data objects that include the one or more particular tracked components.

9. The system of claim 8, wherein determining that one or more particular tracked components satisfy one or more conditions comprises:
in response to determining that the new data object is malicious:
determining that the new data object does not match any existing IDS signatures in a library of IDS signatures; and
selecting, from the identified plurality of components of the new data object, the one or more particular tracked components.

10. The system of claim 8, wherein determining that one or more particular tracked components satisfy one or more conditions comprises one or more of:
determining, for each of the one or more particular tracked components and from the tracking data, that the frequency with which the particular tracked component has been identified in previous data objects determined to be malicious exceeds a first predetermined threshold;
determining, for each of the one or more particular tracked components and from the tracking data, that the frequency with which the particular tracked component has been identified in previous data objects determined not to be malicious is below a second predetermined threshold; or
identifying, for each of the one or more particular tracked components, a respective size of the particular tracked component and determining that a sum of the sizes of the one or more particular tracked components satisfies a third predetermined threshold.

11. The system of claim 8, wherein updating the tracking data comprises:
determining, for each of one or more identified components of the new data object, one or more portions of the identified component that are unstable;
removing, for each of the one or more identified components, the unstable portions of the identified component to generate a respective masked component; and
updating the tracking data using the one or more generated masked components.

12. The system of claim 8, wherein the tracking data further identifies, for each of the plurality of tracked components, a frequency with which the tracked component has been identified in data objects whose maliciousness has been determined to be inconclusive.

13. The system of claim 8, the operations further comprising applying, by an intrusion detection system of a network, the new IDS signature to a second data object as the second data object is entering the network.

14. The system of claim 13, the operations further comprising:
determining that the second data object matches the new IDS signature; and
in response, sending, to a user of the network, an alert that identifies a predicted behavior of the second data object, wherein the predicted behavior is determined according to a behavior of a malicious data object whose components were used to generate the new IDS signature.

15. One or more non-transitory computer storage media encoded with computer program instructions that when executed by a plurality of computers cause the plurality of computers to perform operations
obtaining a new data object and determining whether the new data object is malicious or not malicious;
identifying a plurality of components of the new data object;
updating tracking data using (i) the identified plurality of components of the new data object and (ii) the determination of whether the new data object is malicious or not malicious,
wherein the tracking data identifies, for each of a plurality of tracked components of previous data objects, (i) a frequency with which the tracked component has been identified in previous data objects determined to be malicious and (ii) a frequency with which the tracked component has been identified in previous data objects determined not to be malicious; and
determining, from the tracking data, that one or more particular tracked components satisfy one or more conditions and, in response:
automatically generating a new intrusion detection system (IDS) signature for identifying malicious data objects that include the one or more particular tracked components.

16. The non-transitory computer storage media of claim 15, wherein determining that one or more particular tracked components satisfy one or more conditions comprises:
in response to determining that the new data object is malicious:
determining that the new data object does not match any existing IDS signatures in a library of IDS signatures; and
selecting, from the identified plurality of components of the new data object, the one or more particular tracked components.

17. The non-transitory computer storage media of claim 15, wherein determining that one or more particular tracked components satisfy one or more conditions comprises one or more of:
determining, for each of the one or more particular tracked components and from the tracking data, that the frequency with which the particular tracked component has been identified in previous data objects determined to be malicious exceeds a first predetermined threshold;
determining, for each of the one or more particular tracked components and from the tracking data, that the frequency with which the particular tracked component has been identified in previous data objects determined not to be malicious is below a second predetermined threshold; or
identifying, for each of the one or more particular tracked components, a respective size of the particular tracked component and determining that a sum of the sizes of the one or more particular tracked components satisfies a third predetermined threshold.

18. The non-transitory computer storage media of claim 15, wherein updating the tracking data comprises:
determining, for each of one or more identified components of the new data object, one or more portions of the identified component that are unstable;
removing, for each of the one or more identified components, the unstable portions of the identified component to generate a respective masked component; and
updating the tracking data using the one or more generated masked components.

19. The non-transitory computer storage media of claim 15, wherein the tracking data further identifies, for each of the plurality of tracked components, a frequency with which the tracked component has been identified in data objects whose maliciousness has been determined to be inconclusive.

20. The non-transitory computer storage media of claim 15, the operations further comprising applying, by an intrusion detection system of a network, the new IDS signature to a second data object as the second data object is entering the network.

21. The non-transitory computer storage media of claim 20, the operations further comprising:
determining that the second data object matches the new IDS signature; and
in response, sending, to a user of the network, an alert that identifies a predicted behavior of the second data object, wherein the predicted behavior is determined according to a behavior of a malicious data object whose components were used to generate the new IDS signature.
